(19) United States
(12) Patent Application Publication
(10) Pub. No.: US 2022/0382968 A1
(43) Pub. Date: Dec. 1, 2022

(54) TEXT GENERATION FOR REPORT WRITING

(71) Applicant: MOTOROLA SOLUTIONS, INC., CHICAGO, IL (US)

(72) Inventors: BING QIN LIM, JELUTONG (MY); MING YEH KOH, BDR BARU AIR ITAM (MY); CECILIA LIAW WEI LING, BUTTERWORTH (MY); MOH LIM SIM, BAYAN LEPAS (MY)

(21) Appl. No.: 17/335,120

(22) Filed: Jun. 1, 2021

(51) Int. Cl. G06F 40/174; G06F 3/0481; G10L 15/26; G06K 9/00

(52) U.S. Cl. CPC G06F 40/174; G06F 3/04817; G10L 15/26; G06K 9/00671; G06F 3/04812

(57) ABSTRACT

A method and apparatus for writing a report is described herein. During the process an officer will acquire an image of an incident scene. The image may comprise a live image, a video, or a still image (picture). Potential objects of interest will be highlighted within the image for selection by the officer. When an object of interest is selected (e.g., touched on a touch screen), a description of the object of interest will be inserted at a point in a report where a cursor lies. The user will also be allowed to transcribe (via speech to text) their report, and have text representing their speech inserted where the cursor lies.

### BACKGROUND OF THE INVENTION

Police officers spend over fifty percent of their time in completing incident reports. Over ninety percent of police officers strongly agree that report writing keeps them away from higher-value tasks. Therefore, a need exists to aid police officers in report writing so that less of their time is devoted to this task.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and digital form part of the specification, serve to further illustrate various embodiments and to explain various principles and advantages all in accordance with the present invention.

FIG. 1 illustrates generating text for a report.

FIG. 2 illustrates generating text for a report.

FIG. 3 illustrates generating text for a report.

FIG. 4 illustrates generating text for a report.

FIG. 5 illustrates generating text for a report.

FIG. 6 is a block diagram of a device for aiding in report writing.

FIG. 7 is a flow chart showing operation of the device of FIG. 1.

FIG. 8 is a flow chart showing operation of the device of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for writing a report is described herein. During the process, an officer will acquire an image of an incident scene. The image may comprise a live image, a video, or a still image (picture). Potential objects of interest will be highlighted within the image for selection by the officer. When an object of interest is selected (e.g., touched on a touch screen), a description of the object of interest will be inserted at a point in a report where a cursor lies. The user will be allowed to transcribe (via speech to text) their report, and have text that represents their speech also inserted into the report where the cursor lies.

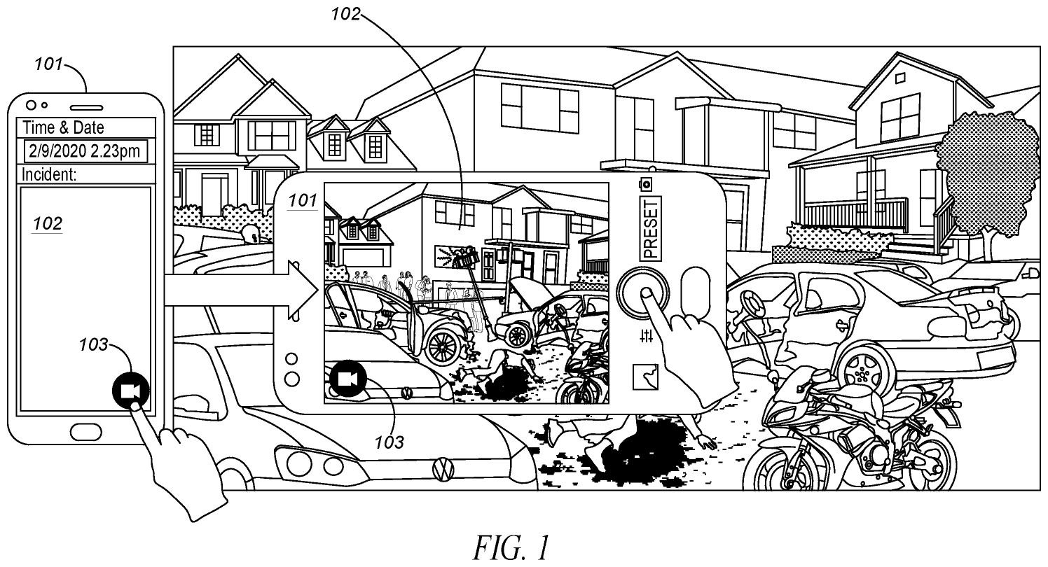

Expanding on the above, consider FIG. 1 through FIG. 5. As shown in FIG. 1, an officer at an incident scene utilizes device 101 to write a report about the incident. Device 101 is also equipped with a camera (not shown) that is capable of imaging the incident scene. Device 101 is also equipped with a microphone and processor (not shown in FIG. 1) that are capable of performing text-to-speech conversion in order to transcribe the officer's voice into text to be filled into the report. Device 101 is also equipped with a graphical-user interface (GUI) 102 capable of displaying text of the report and an image/video of an incident scene. Soft key 103 is provided to toggle between a text screen showing the report and an image of the incident scene. Thus, with a press of soft key 103, GUI 102 is capable of changing between displaying text of a report and an image from a camera.

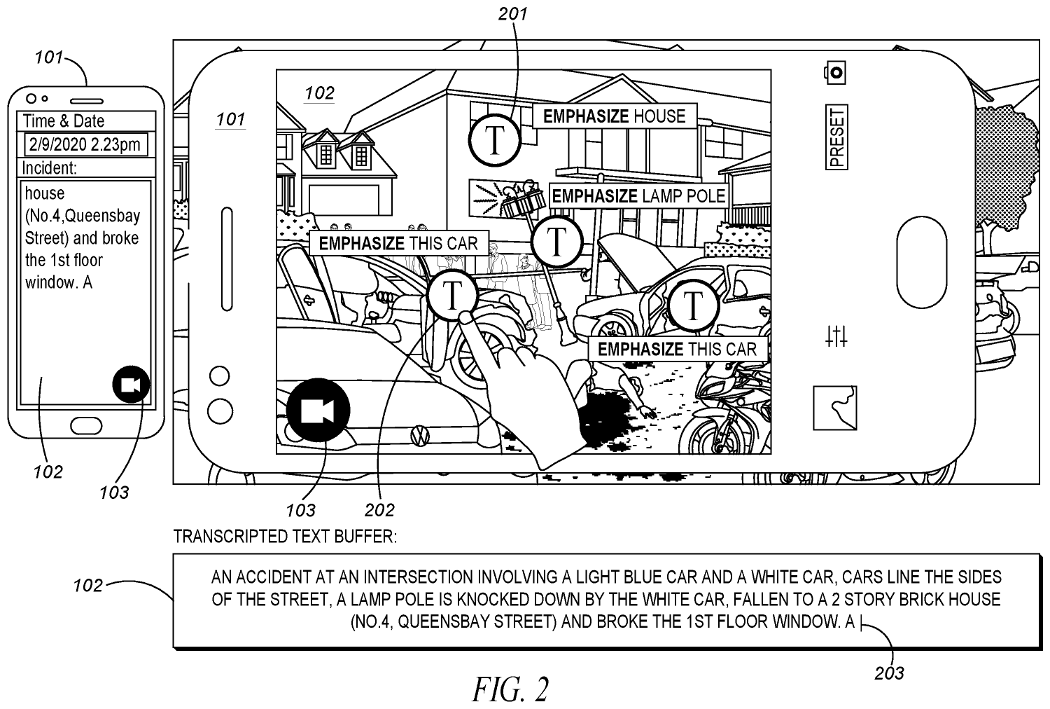

As shown in FIG. 2, when displaying an image of the incident scene, potential objects of interest are displayed on GUI 102 with an associated icon 201 (only one icon 201 labeled in FIG. 2) near or over the object of interest. In one embodiment, the potential objects of interest within the image are public safety objects determined based on an incident type. For example, if an officer's report has a field that identifies a type of incident (e.g., an automobile accident) objects within the image that are related to an automobile accident are identified and associated with an icon 201. In another embodiment, the objects of interest are public safety objects that can are determined based on a Computer Aided Dispatch (CAD) Identifier (ID). For example, device 101 is typically wirelessly connected to a dispatch system or CAD system, and a CAD identifier is assigned to the incident that the officer is attending or dispatched to. Thus based on the CAD identifier, an incident type is determined and a list of objects of interest that are related to the particular incident is retrieved and used to determine the object of interest within the image.

It should be noted that whether or not a CAD ID is utilized to determine a type of incident, or a field of a report is utilized to determine the type of incident, objects of interest will be associated with an icon, wherein the objects of interest may be directly related to the type of incident. In other words, for a first incident type, a set of icons will be associated with a first set of objects of interest in an image, while for a second incident type, a set of icons will be associated with a second set of objects of interest within the image. The first set of objects of interest and the second set of objects of interest may differ based on the incident type. When a recognition engine/video analysis engine (VAE) is utilized to determine various objects of interest (described in more detail below), different incident types may require different recognition engines in order to detect the different object of interest. In other words, for a first incident type, a first VAE may be used to determine a first objects of interest, while for a second incident type, a second VAE may be used to determine second objects of interest.

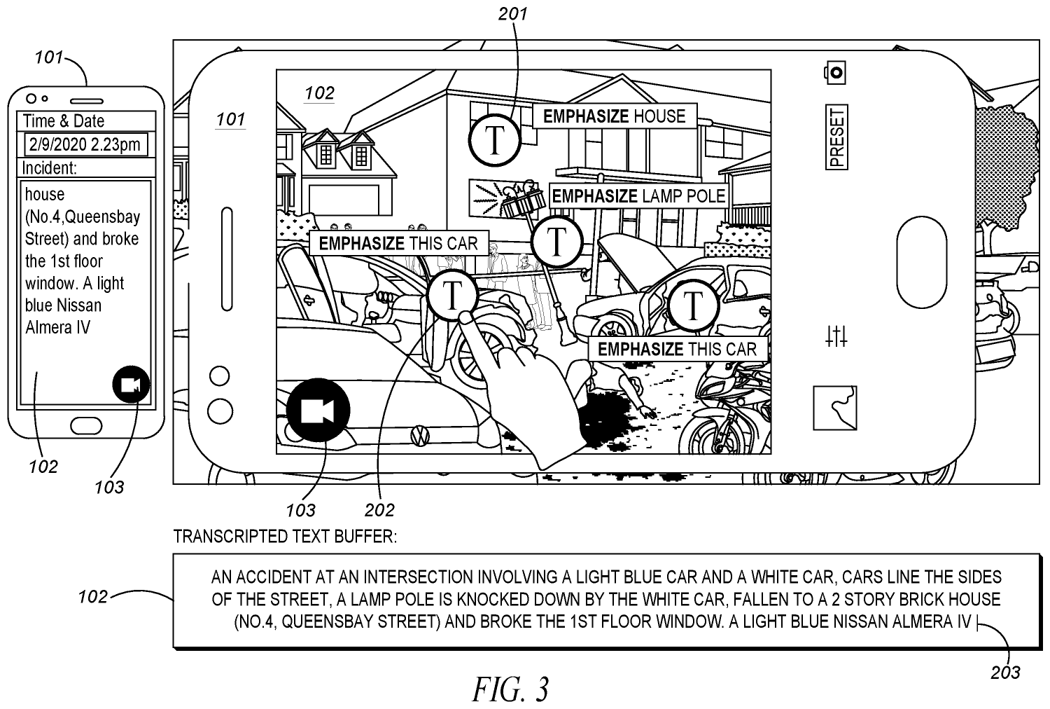

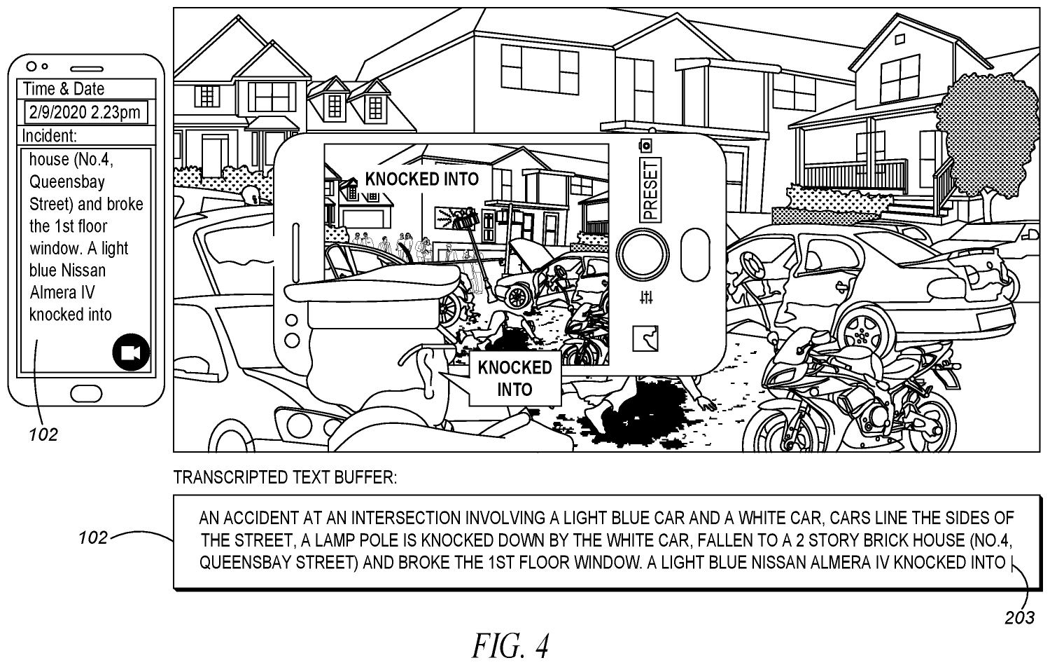

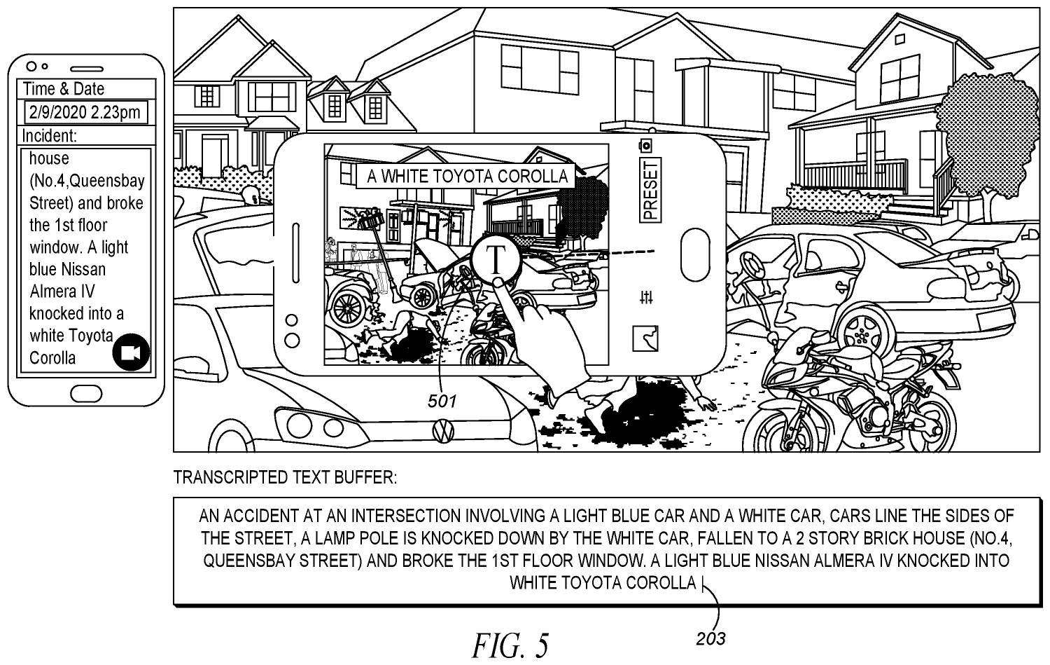

Selecting (by touching or clicking on) any icon will populate a report with information about the object of interest associated with icon 201. In FIG. 2, an officer has typed or dictated “An accident at an intersection involving a light blue car and a white car, cars line the sides of the street, a lamp pole is knocked down by the white car, fallen to a 2-story brick house (No. 4, Queensbay Street) and broke the 1st floor window. A”. The officer then touches icon 202 associated with an automobile. In response to this, information about the associated automobile inserted as text at cursor 203. This is illustrated in FIG. 3 where the text “light blue Nissan Almera IV” is inserted at cursor 203. The cursor then moves to the end of the inserted text. The officer then begins to speak “knocked into”, and the spoken words are converted to text and inserted at the cursor point after “light blue Nissan Almera IV”. This is illustrated in FIG. 4. The officer then touches icon 501 (FIG. 5) associated with an identified automobile. This causes the text “white Toyota Corolla” to be inserted at cursor 203.

As is evident from the above example, the officer may speak to have text inserted at cursor 203, or alternatively, may touch any icon on GUI 102 to have information about the icon's associated object of interest inserted at cursor 203. This allows an officer to more efficiently generate a report about any incident.

In another embodiment, a single icon such as a video shutter button can be used to select objects of interest within the image for a transcription based on a dragging gesture. The icon is preferably draggable and can be dragged by the officer to an object of interest to insert text describing the object of interest into the report. In this embodiment, multiple objects of interest can be indicated in sequence by dragging the icon to the multiple objects of interest in sequence, and the transcription of the multiple objects will be done in the same sequence of icon being dragged on respective multiple objects of interest. For example, if the officer drags the icon to a light blue car, then to a white car, then to a lamp pole, and finally on a house that within an image, the video analytic may transcript those four objects and combine them in the same sequence as that of the dragging gesture, for example “a light blue car a white car, a lamp pole a 2-story brick house (No. 4, Queensbay Street)”. In this example, additional context may be added to the transcription of each object (for example, “knocked down by the white car” is the added context to lamp pole, “2-story”, address “No. 4, Queensbay Street”, and “broke the 1st floor window” is the added context to the selected house) by video analytic processing on those selected object of interest. Other objects within the image that are not being selected, will not be part of the transcription or generalized in the transcription.

In one embodiment, if the video analytic engine determines that an object of interest is too small within the field of view (FOV) of the camera (too far away), a voice prompt or text notification can be provided to the officer to go nearer to the object of interest. For example, if the camera cannot detect a license plate of a vehicle of interest, a voice prompt of “go nearer to the white car” will be output from speaker of the device 101 to request officer go nearer to the vehicle so that a license plate can be detected. In one embodiment, if the video analytic engine determines that the camera is at an angle that some detail of the object may not be properly detected and transcribed (e.g., the license plate is not visible when camera is capturing the vehicle side view), a notification can be send to officer to change the angle of capturing the image of the vehicle.

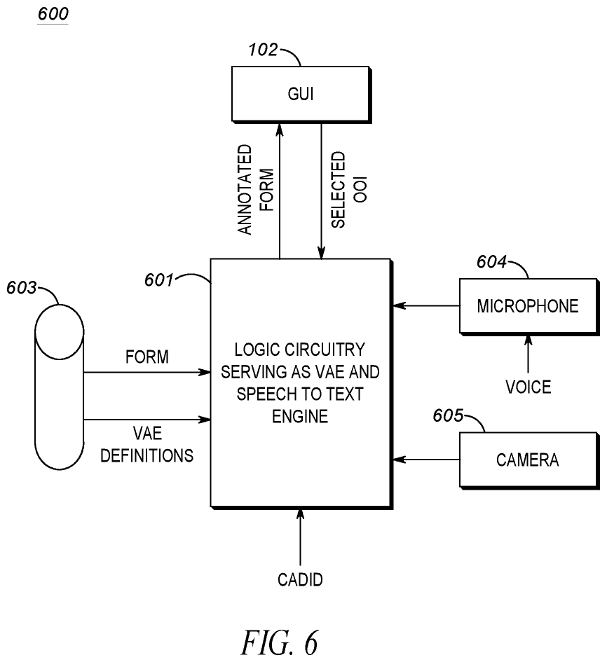

FIG. 6 is a block diagram showing an apparatus configured to insert text into a report as described above. The apparatus may be located within a police radio, smart phone, or any other device. As shown, apparatus 600 comprises microprocessor (logic circuitry) 601 that also serves to execute a video analysis engine (VAE) identifying objects of interest within a field of view of a camera, Graphical-user interface (GUI) 102, storage 603, microphone 604, and camera 605. Although only one GUI 102 is shown in FIG. 1, multiple GUIs may be present. GUI 102 provides a man/machine interface for receiving an input from a user and displaying information. For example, GUI 102 may provide a way of conveying (e.g., displaying) information received from processor 601. Part of this information may comprise an image with icons associated with objects within an image or video. Part of this information may also include text that is part of a report. In order to provide the above features (and additional features), GUI 102 may comprise any combination of a touch screen, a computer screen, a keyboard, or any other interface needed to receive a user input and provide information to the user. As discussed above, a soft button may be provided to toggle between various screens displayed on GUI 102 (e.g., a screen displaying a report, and a screen displaying an image of an incident scene).

Logic circuitry 601 comprises a digital signal processor (DSP), general purpose microprocessor, a programmable logic device, or application specific integrated circuit (ASIC) and is configured to identify objects of interest within an image or video, and annotate the image or video with icons associated with each identified object. In order to determine objects within any video/image, logic circuitry 601 may execute a recognition engine/video analysis engine (VAE) which comprises a software engine that analyzes analog and/or digital video or images. The particular software engine being used can vary, and is stored in storage 603. In one embodiment, various video-analysis engines are stored in storage 603, each serving to identify a particular object (car, weapon, person, . . . , etc.). As discussed above, the type of VAE utilized by logic circuitry 601 may be based on a type of incident being handled by the officer. So, for example, for automobile accidents, a VAE that identifies automobiles may be utilized, while for murder investigations, a VAE that identifies shell casings or weapons may be utilized by logic circuitry 601.

Using the software engine, logic circuitry 601 is able to “watch” a video and/or image and detect/identify objects of interest. The video-analysis engine may contain any of several object detectors as defined by the software engine. Each object detector “watches” the video/image for a particular type of object. For example, automobile object detector software may be utilized to detect automobiles, while a weapon detection software may be utilized to detect weapons.

Database 603 comprises standard memory (such as RAM, ROM, . . . , etc.) and serves to store forms, video, and software engines (VAEs).

Microphone 604 provides a mechanism for receiving human voice and converting the human voice to text representing what was said. With this in mind, logic circuitry 601 is configured to receive human voice and serve as a speech-to-text engine, outputting text representing what was said directly into any report at cursor 203.

Finally, camera 605 comprises a standard digital imager capable of providing logic circuitry 601 with digital images and/or video.

During operation, logic circuitry 601 is configured to receive a digital form (e.g., a report) from database 603, and output the report to GUI 102 to be displayed for an officer to view. As discussed above, text may be inserted into the report by logic circuitry 601 at a cursor point as a result of voice being received from microphone.

As discussed above, logic circuitry 601 is also configured to receive an image or video from camera 605 and output the image or video to GUI 102. Logic circuitry 601 will receive the image/video and VAE from database 603, perform video/image analysis, and identify objects of interest within the received video/image, placing icons next to each identified object of interest. The video/image output to GUI 102 will have icons inserted by logic circuitry 601 that lie near any identified object of interest within the image/video.

Logic circuitry 601 is configured to receive a user input that selects an icon associated with an object of interest, and insert text representing any selected object of interest directly at a cursor 203 within a report.

Thus, as described, text that is inserted into a report may be generated by logic circuitry 601 by converting speech received from microphone 604 into text and inserting the text into a report at a cursor point. Additionally, text that is inserted into a report may be generated by logic circuitry 601 by identifying objects of interest within a video or image, receiving a user selection of an object of interest, and inserting text describing the object of interest into a report at a cursor point. Thus both speech, and selected objects of interest will have associated text inserted at a cursor point. The cursor is preferably moved by logic circuitry 601 to the end of any text that is inserted into the report.

Thus, as described above, FIG. 6 shows apparatus 600 comprising a camera, a graphical-user interface (GUI), and logic circuitry configured to receive an image or video from the camera, perform object recognition on the image or video to recognize particular objects within the image or video, receive a user selection of a particular object within the image or video from the GUI, and insert text into a digital form at a cursor, wherein the text describes the particular object within the image or video.

Apparatus 600 may further comprise a microphone, wherein the logic circuitry is further configured to position the cursor after the inserted text to create a newly-positioned cursor, receive human voice from the microphone, perform a speech to text conversion on the human voice to generate text representing the received human voice, and insert the text representing the received human voice at the newly-positioned cursor.

As discussed, the logic circuitry may perform object recognition by recognizing particular objects based on an incident type or a computer Aided Dispatch (CAD) identifier. The logic circuitry may perform object recognition by recognizing particular objects based on a type of incident identified in a field of a digital form. The logic circuitry may be further configured to modifying the image or video by inserting icons within the image or video near recognized objects, wherein each icon is associated with a recognized object, and wherein the logic circuitry receives the user selection by receiving the user selection of a particular icon.

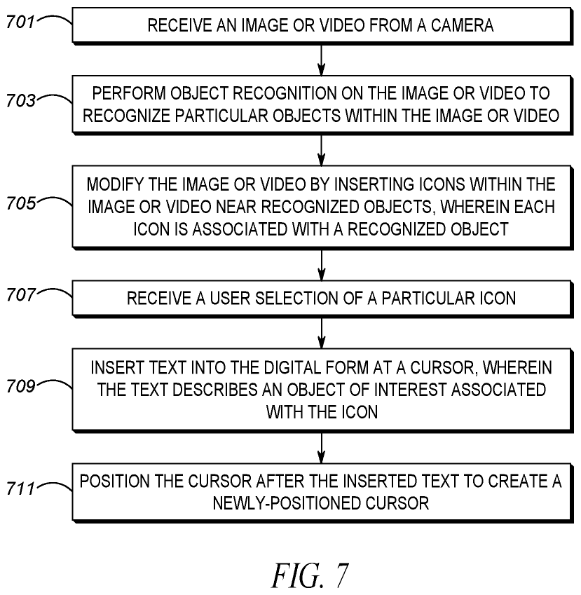

FIG. 7 is a flow chart showing operation of apparatus 600. More particularly, the flow chart of FIG. 7 illustrates method for inserting text into a digital form. The logic flow begins at step 701 where logic circuitry 601 receives an image or video from camera 605. At step 703, logic circuitry performs object recognition on the image or video to recognize particular objects within the image or video. Logic circuitry then modifies the image or video by inserting icons within the image or video near recognized objects, wherein each icon is associated with a recognized object (step 705). The logic flow then continues to step 707 where logic circuitry receives a user selection of a particular icon from GUI 102 and inserts text into the digital form at a cursor (step 709), wherein the text describes an object of interest associated with the icon. Finally, logic circuitry positions the cursor after the inserted text to create a newly-positioned cursor (step 711).

As discussed above, the report can also be populated with text derived from human speech. When this is the case, logic circuitry receives human voice, performs a speech to text conversion on the human voice to generate text representing the received human voice, and inserts the text representing the received human voice at the newly-positioned cursor.

As discussed above, the step of performing object recognition may comprise the step of recognizing particular objects based on an incident type or a computer Aided Dispatch (CAD) identifier.

As discussed above, the step of performing object recognition may comprise the step of recognizing particular objects based on a type of incident identified in a field of a digital form.

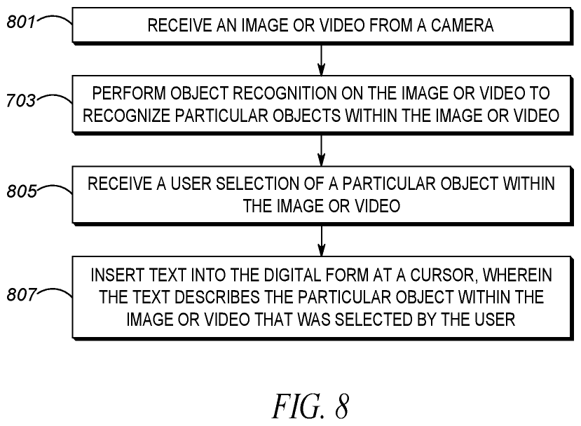

FIG. 8 is a flow chart showing operation of apparatus 600. More particularly, the flow chart of FIG. 8 illustrates method for inserting text into a digital form. The logic flow begins at step 801 where logic circuitry 601 receives an image or video from a camera and performs object recognition on the image or video to recognize particular objects within the image or video (step 803). At step 805, logic circuitry 601 receives a user selection of a particular object within the image or video and inserts text into the digital form at a cursor (step 807). As discussed, the text describes the particular object within the image or video that was selected by the user.

As discussed above, Logic circuitry 601 may also position the cursor after the inserted text to create a newly-positioned cursor, receive human voice from microphone 604, and perform a speech to text conversion on the human voice to generate text representing the received human voice. The text representing the received human voice may be inserted at the newly-positioned cursor.

As discussed above, the step of receiving the user selection of the particular object within the image or video may comprise the step of receiving an indication that an icon associated with the particular object has been selected.

As discussed above, the step of receiving the user selection of the particular object within the image or video comprises the step of receiving an indication that an icon has been slid into proximity with the particular object.

As discussed above, the step of performing object recognition may comprise the step of recognizing particular objects based on an incident type or a computer Aided Dispatch (CAD) identifier. As shown in FIG. 6, the CAD ID may be directly input into logic circuitry 601, being received at a transceiver (not shown in FIG. 6) from an over-the-air transmission from, for example, a dispatch center.

As discussed above, the step of performing object recognition may comprise the step of recognizing particular objects based on a type of incident identified in a field of a digital form. More particularly, the form may be received from database 603 and presented to the user to be populated. Field of the form may be populated by the user using GUI 102. One of the fields may comprise an incident type that is used by logic circuitry 601 to determine what object of interest to search for within the image.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for inserting text into a digital form, the method comprising the steps of:
receiving an image or video from a camera;
performing object recognition on the image or video to recognize particular objects within the image or video;
modifying the image or video by inserting icons within the image or video near recognized objects, wherein each icon is associated with a recognized object;
receiving a user selection of a particular icon;
inserting text into the digital form at a cursor, wherein the text describes an object of interest associated with the icon; and
positioning the cursor after the inserted text to create a newly-positioned cursor.

2. The method of claim 1 further comprising the steps of:
receiving human voice;
performing a speech to text conversion on the human voice to generate text representing the received human voice; and
inserting the text representing the received human voice at the newly-positioned cursor.

3. The method of claim 1 wherein the step of performing object recognition comprises the step of recognizing particular objects based on an incident type or a computer Aided Dispatch (CAD) identifier.

4. The method of claim 1 wherein the step of performing object recognition comprises the step of recognizing particular objects based on a type of incident identified in a field of a digital form.

5. A method for inserting text into a digital form, the method comprising the steps of:
receiving an image or video from a camera;
performing object recognition on the image or video to recognize particular objects within the image or video;
receiving a user selection of a particular object within the image or video; and
inserting text into the digital form at a cursor, wherein the text describes the particular object within the image or video that was selected by the user.

6. The method of claim 5 further comprising the steps of:
positioning the cursor after the inserted text to create a newly-positioned cursor;
receiving human voice;
performing a speech to text conversion on the human voice to generate text representing the received human voice; and
inserting the text representing the received human voice at the newly-positioned cursor.

7. The method of claim 5 wherein the step of receiving the user selection of the particular object within the image or video comprises the step of receiving an indication that an icon associated with the particular object has been selected.

8. The method of claim 5 wherein the step of receiving the user selection of the particular object within the image or video comprises the step of receiving an indication that an icon has been slid into proximity with the particular object.

9. The method of claim 5 wherein the step of performing object recognition comprises the step of recognizing particular objects based on an incident type or a computer Aided Dispatch (CAD) identifier.

10. The method of claim 5 wherein the step of performing object recognition comprises the step of recognizing particular objects based on a type of incident identified in a field of a digital form.

11. An apparatus comprising:
a camera;
a graphical-user interface (GUI);
logic circuitry configured to;
receive an image or video from the camera;
perform object recognition on the image or video to recognize particular objects within the image or video;
receive a user selection of a particular object within the image or video from the GUI; and
insert text into a digital form at a cursor, wherein the text describes the particular object within the image or video.

12. The apparatus of claim 11 further comprising:
a microphone;
wherein the logic circuitry is further configured to:
position the cursor after the inserted text to create a newly-positioned cursor;
receive human voice from the microphone;
perform a speech to text conversion on the human voice to generate text representing the received human voice; and
insert the text representing the received human voice at the newly-positioned cursor.

13. The apparatus of claim 11 wherein the logic circuitry performs object recognition by recognizing particular objects based on an incident type or a computer Aided Dispatch (CAD) identifier.

14. The apparatus of claim 11 wherein the logic circuitry performs object recognition by recognizing particular objects based on a type of incident identified in a field of a digital form.

15. The apparatus of claim 11 wherein the logic circuitry is further configured to:
modifying the image or video by inserting icons within the image or video near recognized objects, wherein each icon is associated with a recognized object; and
wherein the logic circuitry receives the user selection by receiving the user selection of a particular icon.
